(19) United States
(12) Patent Application Publication
(10) Pub. No.: US 2026/0370516 A1
(43) Pub. Date: Nov. 19, 2026

(54) DISTRIBUTED REINFORCEMENT LEARNING SYSTEM WITH LINK-LEVEL CONTROL AND CONVOLUTIONAL NEURAL NETWORK (CNN) ARCHITECTURE FOR DATACENTER NETWORK POWER MANAGEMENT

(71) Applicant: NVIDIA Corporation, Santa Clara, CA (US)

(72) Inventors: Jonathan Paul, Tel Aviv (IL); Amit Kazimirsky, Givat Shmuel (IL); Gal Chechik, Ramat Hasharon (IL); Gal Dalal, Shimshit (IL)

(21) Appl. No.: 19/360,642

(22) Filed: Oct. 16, 2025

Related U.S. Application Data
(60) Provisional application No. 63/806,199, filed on May 15, 2025.

(51) Int. Cl. H04L 12/54; G06N 3/0464; G06N 3/092

(52) U.S. Cl. CPC H04L 12/56; G06N 3/0464; G06N 3/092

(57) ABSTRACT

Systems and methods are disclosed that provide for controlling network links in a datacenter environment using a reinforcement learning (RL) agent. For instance, embodiments of the present disclosure describe a distributed reinforcement learning (RL) framework (LinkRL framework) for dynamic link power management of datacenter switches. The LinkRL framework deploys lightweight RL agents that operate at the individual link level, and each agent learns an adaptive policy to toggle its link between active and low-power states based on observed traffic patterns. The LinkRL framework may perform predictive traffic modeling. For example, the RL agents may learn to anticipate future network activity, which may allow the RL agents to preemptively wake links before traffic arrives, which may minimize latency penalties, and identify extended idle periods where links may safely sleep, which may maximize energy savings.

### CLAIM OF PRIORITY

This application claims the benefit of U.S. Provisional Application No. 63/806,199 Attorney Docket No. 515515) titled “Distributed Reinforcement Learning System With Link-Level Control And Cnn Architecture For Datacenter Network Power Management,” filed May 15, 2025, the entire contents of which is incorporated herein by reference.

### BACKGROUND

Modern datacenters face escalating energy demands, with networking infrastructure contributing to roughly 20% of their total power consumption. Network links connect nodes such as graphics processing units (GPUs) or switches within the datacenter, and these links remain idle approximately 50-80% of the time, especially during GPU computation phases. Despite being inactive, idle links consume nearly as much power as active links, and this inefficiency presents a significant energy-saving opportunity.

Managing link power dynamically presents a fundamental challenge between balancing energy savings and network performance. For instance, when links enter low-power (sleep) states, they conserve significant energy. But, transitioning a link to an active state introduces delays exceeding 100 microseconds (μs). This wake-up penalty is substantial compared to typical datacenter network latencies (e.g., under 10 μs), and these delays directly impact job completion times especially in distributed machine learning workloads where increasing parallelization demands more frequency network communication. As such, there is a need for addressing these issues and/or other issues associated with the prior art.

### SUMMARY

Embodiments of the present disclosure relate to distributed reinforcement learning (RL) system with link-level control and convolutional neural network (CNN) architecture for datacenter network power management. Systems and methods are disclosed that utilize a distributed reinforcement learning framework to manage datacenter power by toggling network links between active and low-power states. For instance, embodiments of the present disclosure describe an effective link management approach using RL that adapts to traffic patterns in real-time and balances power conservation with performance preservation.

As mentioned above, modern datacenters face escalating energy demands, and their inefficiency presents a significant energy-saving opportunity. However, conventional approaches struggle to adapt to the dynamic traffic patterns found in modern workloads, and are found vulnerable to distribution shift when deployed on evolving workloads. Furthermore, it has been shown that effective link management must adapt to traffic patterns in real-time, balancing power conservation and performance preservation.

Thus, in contrast to conventional systems, such as those described above, embodiments of the present disclosure describe a distributed reinforcement learning (RL) framework (LinkRL framework) for dynamic link power management in datacenter switches. The LinkRL framework deploys lightweight RL agents that operate at the individual link level, and each agent learns an adaptive policy to toggle its link between active and low-power states based on observed traffic patterns. The LinkRL framework may perform predictive traffic modeling. For example, the RL agents may learn to anticipate future network activity, which may allow the RL agents to preemptively wake links before traffic arrives. This may minimize latency penalties and identify extended idle periods where links may safely sleep, which may maximize energy savings. This will be described in further detail below.

In an embodiment, a computer-implemented method for controlling network links in a datacenter environment using a reinforcement learning (RL) agent is provided. The method includes obtaining first information indicating a first state representation of initial network traffic of the datacenter environment, and the first state representation is associated with a network link between a first switch and a hardware element. The method further includes processing the first state representation using the RL agent to generate a first action indicating for the first switch to transition the network link to a low-power state and transitioning the network link to the low-power state. The network link is incapable of forwarding a data packet to the hardware element in the low-power state. The method also includes obtaining second information indicating a second state representation of updated network traffic of the datacenter environment and processing the second state representation using the RL agent to generate a second action indicating for the first switch to transition the network link to an active state. Prior to the first switch obtaining a first data packet that is to be forwarded to the hardware element, the method additionally includes transitioning the network link to the active state and obtaining and forwarding the first data packet to the hardware element based on transitioning the network link to the active state.

### BRIEF DESCRIPTION OF THE DRAWINGS

The present systems and methods for distributed reinforcement learning (RL) system with link-level control and convolutional neural network (CNN) architecture for datacenter network power management are described in detail below with reference to the attached drawing figures, wherein:

FIG. 1A shows an overview for training an RL agent, in accordance with an embodiment;

FIG. 1B shows another overview for training the RL agent, in accordance with an embodiment;

FIG. 1C show an exemplary embodiment of the RL agent, in accordance with an embodiment;

FIG. 1D shows another exemplary embodiment of the RL agent, in accordance with an embodiment;

FIG. 1E shows yet another exemplary embodiment of the RL agent, in accordance with an embodiment;

FIG. 2 shows an example of an inference phase of using the RL agents in a distributed data center, in accordance with an embodiment;

FIG. 3 illustrates a flowchart of a method for controlling network links in a datacenter environment using an RL agent, in accordance with an embodiment;

FIG. 4 is a conceptual diagram of a processing system implemented using a PPU, suitable for use in implementing some embodiments of the present disclosure;

FIG. 5A illustrates an exemplary system in which the various architecture and/or functionality of the various previous embodiments may be implemented;

FIG. 5B illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

Systems and methods are disclosed herein that relate to distributed reinforcement learning (RL) system with link-level control and convolutional neural network (CNN) architecture for datacenter network power management, and in particular, to an LinkRL framework for dynamic link power management of datacenter switches. For example, embodiments of the present disclosure describe a LinkRL framework that manages datacenter power by toggling network links between active and low-power states. In some variations, embodiments of the present disclosure may target the substantial energy these links consume while idle during computation phases.

As mentioned previously, modern datacenters face escalating energy demands, with power consumption becoming a critical bottleneck for computational scaling. Networking infrastructure accounts for approximately 20% of this total power, and the inefficiency of idle links presents a significant optimization opportunity. In LinkRL, lightweight per-link agents may be trained to predict traffic patterns, enabling preemptive sleep and wake-up.

Previous approaches include threshold-based policies that shift links to low-power states after a fixed idle period, pattern-predictor methods that use scoreboards to forecast recurring idle periods, and/or supervised and/or Bayesian learning approaches that train offline models to predict idle period durations based on historical traffic patterns (e.g., based on applying Bayesian optimization for deployment tuning). Embodiments of the present disclosure were evaluated on real-world large language model (LLM) training workloads using a high-fidelity datacenter network simulator and successfully generalize to unseen traffic patterns. LinkRL was shown to achieve 8% total datacenter power savings while maintaining network latency, which significantly outperforms existing threshold-based, pattern predictor, and supervised learning methods. Furthermore, reallocating these power savings to compute resources translates into a 7% increase in GPU performance. LinkRL has been incorporated into next-generation networking hardware, and has demonstrated practical deployability at scale.

To address the challenges of the previous approaches described above, embodiments of the present disclosure describe LinkRL, which is a distributed RL framework for dynamic link power management in datacenter switches. Embodiments of the present disclosure may deploy lightweight agents that operate at the individual link level. Each agent may learn an adaptive policy to toggle its link between active and low-power states based on observed traffic patterns. In some examples, LinkRL may be used for predictive traffic modeling. For instance, agents may learn to anticipate future network activity, allowing them to: (i) preemptively wake links before traffic arrives, minimizing latency penalties, and (ii) identify extended idle periods where links may safely sleep, maximizing energy savings. Embodiments of the present disclosure were integrated with a high-fidelity datacenter network simulator, which enabled accurate modeling of distributed LLM training workloads and precise assessment of both performance impact and power savings.

Embodiments of the present disclosure were evaluated against three baselines: two silicon-deployed methods (e.g., threshold-based and pattern predictor approaches) and a third Supervised-Bayesian approach, using diverse real-world traffic patterns from large-scale LLM training workloads. It was shown that embodiments of the present disclosure achieves a better balance between energy conservation and network performance. For instance, across simulation scenarios, LinkRL delivers 8% total datacenter power savings, with findings supported by hardware correlation studies. Analysis of upper bounds indicates that a perfect power management policy may yield up to 11% to 12% power savings, highlighting that LinkRL achieves a large fraction of the potential gains. When these power savings are reallocated to compute resources, hardware tests indicate a performance improvement of approximately 5% to 8% in GPU throughput. Beyond simulation results, LinkRL's viability is confirmed by its successful integration into next-generation networking hardware.

As will be described below, embodiments of the present disclosure may provide a distributed RL framework that manages datacenter network links at fine granularity, adaptively balancing energy efficiency against performance constraints. For example, the LinkRL framework may include an RL agent architecture, neural network (NN) models, a proximal policy optimization (PPO)-based training system, and/or multi-agent deployment strategy. Additionally, and/or alternatively, embodiments of the present disclosure may use a specialized neural architecture leveraging CNNs to detect temporal traffic patterns, enabling proactive power state decisions that minimize latency penalties while maximizing energy savings. Real-world impact through empirical evidence showed an 8% datacenter power savings translating to 7% GPU performance improvement, with technology already integrated into commercial networking hardware. Furthermore, comprehensive analysis validated the multi-agent approach described by embodiments of the present disclosure, and demonstrated the benefits of distributed learning and cross-link knowledge sharing.

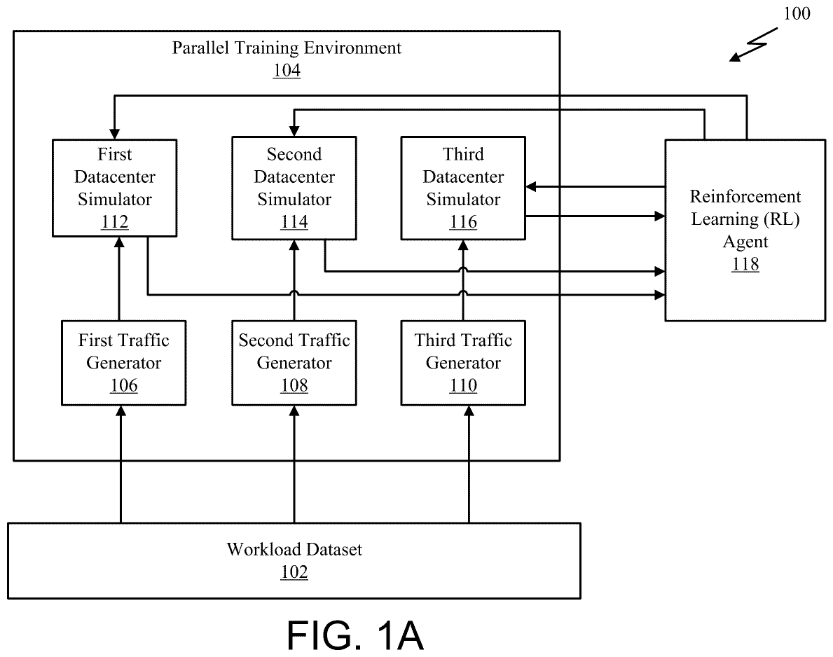

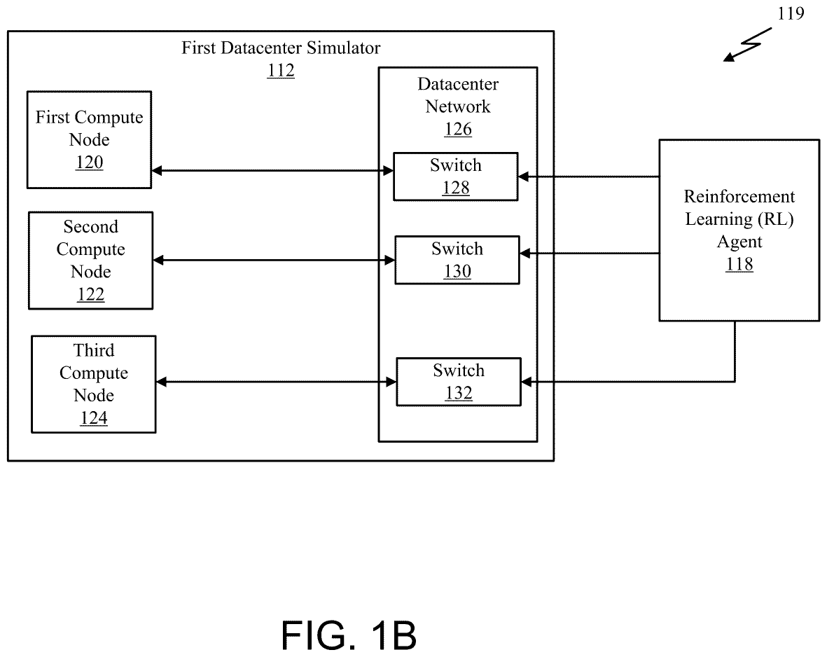

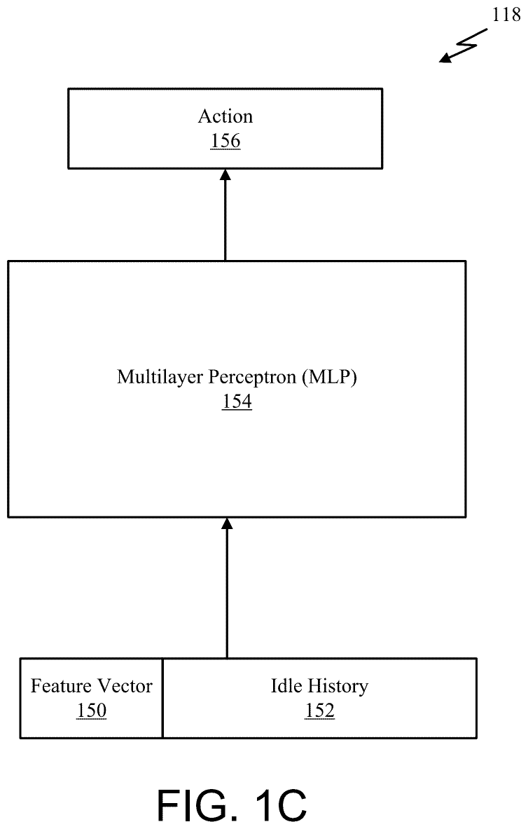

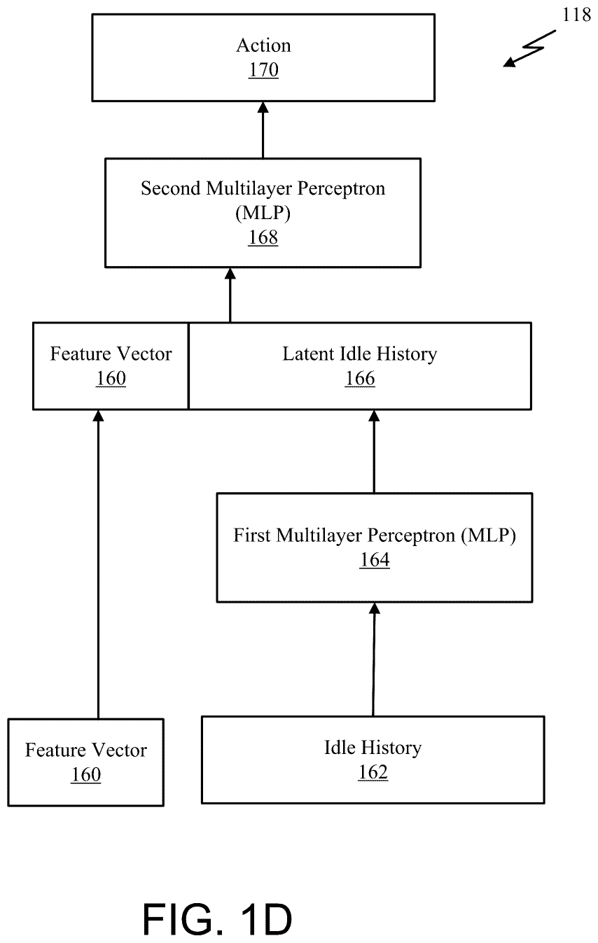

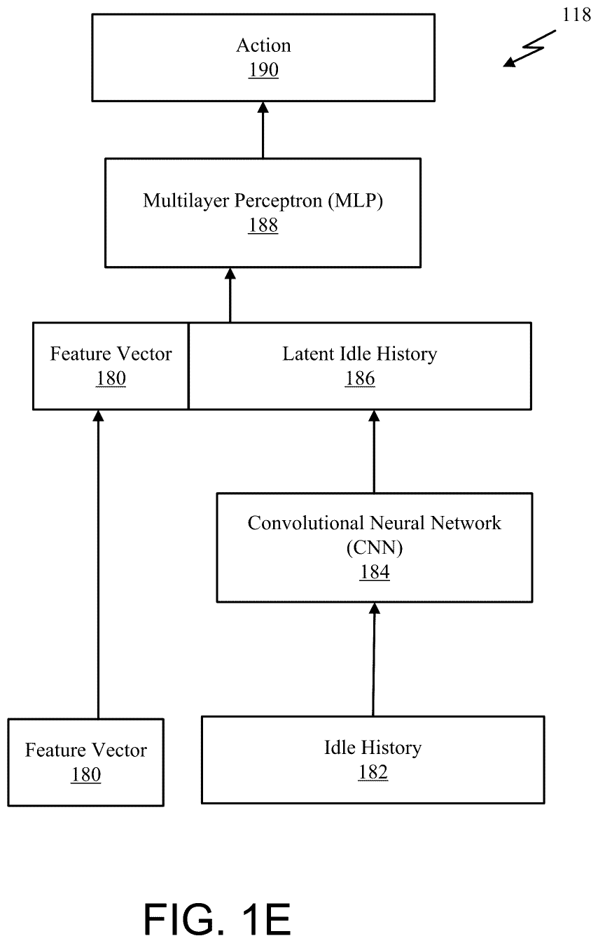

The LinkRL framework includes a training phase for training the RL agent and an inference phase for using the RL agent(s) within a data center environment. For instance, FIG. 1A shows an overview 100 for training an RL agent 118, in accordance with an embodiment. The overview 100 includes a workload dataset 102 (e.g., a large language model (LLM) training and/or inference dataset, a vision training and/or inference dataset, and/or another dataset), a parallel training environment 104, and an RL agent 118. The overview 100 may use a computing process that may be performed using any combination of hardware, firmware, and/or software. For instance, various functions may be carried out by a processor executing instructions stored in memory. The overview 100 may also be embodied as computer-usable instructions stored on computer storage media. The overview 100 may be provided by a standalone application, a service or hosted service (standalone or in combination with another hosted service), or a plug-in to another product, to name a few. In addition, the overview 100 is described, by way of example, with respect to any one system, or any combination of systems, including, but not limited to, those described herein. Furthermore, persons of ordinary skill in the art will understand that any system that performs the overview 100 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

For instance, embodiments of the present disclosure may use the overview 100 to formulate dynamic link power management as an RL problem. The objective may be to learn a policy π that controls when network links transition between active and low-power states. This approach may minimize energy consumption while maintaining application performance. Prior to describing the overview 100 in further detail, the problem formulation is initially described. For instance, the network simulation aspects are first described and following, the Markov decision process (MDP) formulation, including state space, action space, and reward design that balances energy savings with performance requirements, is described.

For example, modern datacenter networks handle increasingly complex workloads with emergent network phenomena. To accurately study these dynamics, embodiments of the present disclosure use a simulation environment (e.g., the parallel training environment 104) for testing all networking feature development and software. The parallel training environment 104 may provide detailed modeling of network behavior including buffer dynamics and packet timing. For instance, the parallel training environment 104 may model each link independently, mirroring real datacenter deployments. Parallelization may be achieved by running multiple simulator instances simultaneously with different LLM workloads, enabling efficient exploration of large state spaces. Each instance may capture both packet-level data and application metrics, quantifying energy savings and performance impacts. The parallel training environment 104 was validated against physical hardware in datacenters, and demonstrated less than a 5% error in latency predictions.

Embodiments of the present disclosure integrate agents (e.g., RL agents 118) with the parallel training environment 104, which may be configured as a compatible environment. Embodiments of the present disclosure may extract per-link observations for each agent, such as idle time, current power state duration, and/or recent traffic history. These observations may then be compressed and discretized to enhance learning stability and reduce the gap between simulation and real-world hardware deployment. Embodiments of the present disclosure may deploy multiple instances of the same policy network, with each instance controlling a single link independently based on its local observations. This decentralized approach with shared weights may allow for scalable deployment.

In some examples, the parallel training environment 104 may accurately model the substantial wake-up latency (e.g., often exceeding 100 μs) incurred when a link transitions from a low-power state back to an active state. This latency is more than an order of magnitude greater than typical datacenter network round-trip times (e.g., often below 10 μs). The parallel training environment's 104 precision in modeling this delay allows for quantifying both the immediate network-level impact when packets arrive at sleeping links and the subsequent effects on application-level performance, such as job completion time. These performance considerations are particularly significant for distributed LLM training, where increasing parallelization leads to more frequent and latency-sensitive communication patterns.

The MDP formulation is now described. Given this simulated environment (e.g., the parallel training environment 104), embodiments of the present disclosure may formulate the power management task for each network link as an independent MDP. Each agent (e.g., each RL agent 118), responsible for a single link, may aim to learn a policy π (aₜ|sₜ) to optimize its link's power states over time.

For the state representation, at each timestep t, every agent (e.g., every RL agent 118) observes a local state sₜ for its associated link. This state vector may be configured to be compact yet informative, and may include, but is not limited to, a consecutive idle time (e.g., the time elapsed since the last data packet was transmitted or received on the link), a time in current power state (e.g., a duration the link has spent in its current power state such as an active or a specific low-power state), a recent traffic-triggered wake-up (e.g., a binary flag indicating if the link was recently forced to transition from a low-power to an active state due to incoming traffic), and/or traffic history features (e.g., a summarized representation of recent traffic patterns, such as a short history of idle period durations, to help predict future activity).

The link state representation may utilize symmetrical features. This may ensure that for a link connecting two switches, the state observed may be identical regardless of which switch's agent is making the decision, enabling consistent behavior with a shared policy.

The action space is now described. For instance, at each timestep t, the agent selects an action aₜ from a discrete set for its link. The action may include: 1) Enter/Remain in Low-Power State (e.g., instruct the link to transition to (or continue in) a designated low-power state); or 2) Enter/Remain in Active State (e.g., instruct the link to transition to (or continue in) the fully active, operational state). These actions allow agents (e.g., the RL agents 118) to proactively manage link power states based on learned predictions, balancing energy saving goals against the performance implications of state transition latencies.

The reward function is now described. The reward function rₜ at each timestep may be crafted to guide the agent (e.g., the RL agents 118) towards the dual objectives of maximizing energy conservation and minimizing negative performance impacts. The reward function may comprise two primary components: 1) an Energy Savings Bonus (e.g., a positive reward proportional to the duration the link successfully spends in a low-power state, directly reflecting conserved energy) and 2) a Forced Wake-Up Penalty (e.g., a significant negative reward issued if a data packet arrives when the link is in a low-power state, thereby forcing an unplanned (and high-latency) transition to the active mode).

The overall per-step reward may be a weighted combination of these factors:

rₜ=α·TimeInLowPowerStateₜ−β·ForcedWakeUpEventₜ (1)

where α>0 and β>0 are hyperparameters that tune the trade-off. This immediate, per-step reward structure may be a form of reward shaping. The ultimate optimization objective may be to maximize total energy saved over entire operational cycles while minimizing job completion time increases. However, such objectives provide only sparse reward signals. The shaped proxy rewards deliver denser feedback, crucial for efficient learning in complex environments.

The optimization objective is now described. For example, each agent (e.g., the RL agents 118) aims to learn an optimal policy π* that maximizes the expected sum of discounted future rewards:

$${π}^{*} = arg {max}_{π} 𝔼 [ {\sum }_{t = 0}^{∞} {γ}^{t} {r}_{t} ]$$

where γ∈[0,1) is the discount factor. By optimizing this objective, the agent learns to make power state decisions that effectively balance energy efficiency with performance requirements. The shaped rewards enable efficient learning despite the inherently sparse nature of the true objective function in LLM training environments.

The overview 100 will now be described in view of the problem formulation described above. For instance, the overview 100 may use the MDP formulation including the state space, action space, and reward design to train the RL agent 118. Furthermore, the overview 100 may also use the parallel training environment 104 to train the RL agent 118. For instance, the parallel training environment 104 may obtain data from the workload dataset 102 and then use the traffic generators 106-110 and/or the datacenter simulators 112-116 to generate training data (e.g., the state spaces) for training the RL agent 118. For example, the workload dataset 102 may include data that may be used to train the RL agent. In some examples, the workload dataset 102 may include LLM datasets such as LLM training and/or inference datasets. For example, the workload dataset 102 may be and/or include packet-level traces from distributed LLM jobs.

Each traffic generator 106-110 may obtain workload data (e.g., LLM training data) from the workload dataset 102. For instance, the first traffic generator 106 may obtain first workload data and process the first workload data to generate a first traffic generator output. Similarly, the second and third traffic generators 108 and 110 may obtain second workload data and third workload data, and generate second and third traffic generator outputs. For instance, the traffic generators 106-110 may replay the workload data from the workload dataset 102 to drive the simulator and generate the traffic generator outputs.

The datacenter simulators 112-116 may process the traffic generator outputs (e.g., the first, second, and third traffic generator outputs) to generate datacenter simulator outputs. In some examples, each of the datacenter simulator outputs may be provided by the RL agent 118, and the datacenter simulator outputs may indicate state representations associated with a simulated network state of the datacenter. In other words, the RL agent 118 may use features such as an idle time, time in current state, recent forced wake-up flag, and traffic history both during training and inference. During training, the parallel training environment 104 (e.g., the traffic generators 106-110 and the datacenter simulators 112-116) may simulate these features based on the LLM traffic traces (e.g., based on the workload dataset 102). During inference, which will be described in further detail below, these features may be obtained from hardware timers, counters, and/or other components or hardware elements of the ports and/or switches. To put it another way, during training, the workload dataset 102 (e.g., the packet traces) may be used by the parallel training environment 104 to generate state representations (e.g., state vectors) of a plurality of features. The features may then be used by the RL agent 118 for agent learning. In contrast, during inference, switch counters, timers, and/or other hardware elements may be used to generate the same and/or similar state representations (e.g., state vectors), which are then used by the trained RL agent 118. The training phase will be described initially below, and then the inference phase will be described afterwards.

For instance, during training, a first datacenter simulator output from the first datacenter simulator 112 may include a first state representation, a second datacenter simulator output from the second datacenter simulator 114 may include a second state representation, and a third datacenter simulator output from the third datacenter simulator 116 may include a third state representation. The RL agent 118 may process multiple state representations associated with different network states within the data center environment. For example, each RL agent 118 may be associated with a different physical location within the data center environment. For instance, the data center environment may include a plurality of hardware components (e.g., GPUs and/or other hardware components and/or elements) that are in electrical communication with each other. For instance, a first GPU may be connected to a plurality of different GPUs such as a second GPU, a third GPU, a fourth GPU, and so on.

To electrically communicate between the first GPU and another GPU such as a second GPU, electrical circuitry such as one or more connecting devices and/or components (e.g., switches and/or links) may be utilized. For instance, the first GPU may provide information (e.g., a data packet) to a second GPU in another physical location within the data center. Electrical circuitry, which includes one or more switches (e.g., three switches), may be used to facilitate this communication. For example, a network link (e.g., an electrical connection) may electrically connect the first GPU to a first hardware element such as a first switch. For instance, the switch may include a plurality of network ports and each port may be associated with a network link (e.g., electrical connection) between a first device (e.g., the first device) and a second device (e.g., a second switch or the second GPU). In an example, three switches may be used to connect the first GPU to the second GPU. As such, a first network link may connect the first GPU to a first switch, a second network link may connect the first switch to the second switch, a third network link may connect the second switch to the third switch, a fourth network link may connect the third switch to the second GPU. In other words, a link may be associated with a connection between two switches and/or between a type of hardware component (e.g., GPU) and a switch. Each switch may be configured to operate its associated link between a first state such as an active state and a second state such as a low-power (sleep) state.

In the active state, the link may be ready to transmit information from a start-point (e.g., the second switch) to an end-point (e.g., the third switch). In the low-power (sleep) state, the link may be configured to conserve significant energy and might not be ready to transmit information from the start-point to the end-point. For the link to transition between the first state to the second state (e.g., the active state to the low-power state), a transition time period (e.g., a wake-up latency) such as 100 μs may be required. Thus, if the first GPU seeks to provide information to the second GPU and a link within their communication path is in the low-power state, the communication will be delayed by the transition time period, which causes network inefficiency. In other words, if all of the links between the first GPU and the second GPU are in the active state (e.g., there is no transition time period necessary), then the information may be transferred between the two GPUs in a short amount of time such as 10 μs. However, if even one link is in the low-power state and is required to be transitioned into the active state, then this adds 100 μs to the communication time. On the other hand, if all of the links are always active, this causes significant power usage. As such, embodiments of the present disclosure may train one or more RL agents 118 that processes network conditions of the data center environment to determine whether to transition the link from the active state to the low-power state or from the low-power state to the active state, which allows for a better balance between energy conservation and network performance for the data center environment.

During inference, the LinkRL framework may be a distributed RL framework that manages datacenter network links at fine granularity based on adaptively balancing energy efficiency against performance constraints. To put it another way, the data center environment may include multiple different RL agents that are spread across the environment. For instance, in some examples, each switch and/or link may include an RL agent that is configured to provide instructions to links to transition them from a first state (e.g., active state) to a second state (e.g., low-power state), or vice versa. Thus, during training, the LinkRL framework may be configured to achieve training via parallelization based on running multiple simulator instances simultaneously, which enables efficient exploration of large state spaces. For instance, three datacenter simulators 112-116 are shown in FIG. 1A and each datacenter simulator may generate a datacenter simulator output (e.g., a state representation) to the RL agent 118. However, as mentioned above, the data center environment may include a plurality of switches and/or links (e.g., hundreds, thousands, and/or even more switches and/or links) that are configured to connect to a plurality of hardware elements (e.g., numerous different GPUs and/or other hardware elements). As such, during training, while only three are shown in FIG. 1A, the parallel training environment 104 may include a plurality of datacenter simulators (e.g., ten, twenty, a hundred, and so on) that each may provide a datacenter simulator output to the RL agent 118.

As mentioned above, each datacenter simulator output may indicate a state representation at a first time step. For instance, the state representation may be and/or include a vector that indicates a plurality of state information such as consecutive idle time, time in current power state, recent traffic-triggered wake-up, and/or traffic history features. For instance, the consecutive idle time may indicate the time elapsed since the last data packet was transmitted or received on the link. The time in current power state may indicate a duration the link has spent in its current power state (e.g., in the active state or a specific low-power state). The recent traffic-triggered wake-up may indicate a binary flag indicating if the link was recently forced to transition from a lower-power to an active state due to incoming traffic. The traffic history features may indicate a summarized representation of recent traffic patterns, such as a short history of idle period durations, to help predict future activity. In some instances, the state representation (e.g., link state representation) may utilize symmetrical features, which may ensure that for a link connecting two switches, the state observed by either switch may be identical regardless of which switch's RL agent is making the decision. By utilizing symmetric features, this may enable consistent behavior with a shared policy.

Based on the state representations, the RL agent 118 may generate RL outputs, which may indicate actions for each of the links. For instance, in some variations, each RL output may be a binary output that either instructs the link to transition to (or continue in) a first state (e.g., a fully active, operational state) or a second state (e.g., a low-power state). For instance, for each state representation, the RL agent 118 may process the state representation and provide an RL output. This is described in further detail in FIG. 1B.

FIG. 1B shows another overview 119 for training the RL agent, in accordance with an embodiment. For example, aspects of the first datacenter simulator 112 from the overview 100 are shown in the overview 119. As shown, three compute nodes are shown 120-124 that are connected to three switches 128-132 of the datacenter network 126. The RL agent 118 may provide RL outputs to each switch 128-132 (e.g., provide three RL outputs). Each RL output may indicate whether the switches 128-132 for the compute nodes 120-124 should be in a first state or a second state. For instance, based on the state representation associated with the first compute node 120 (e.g., a first GPU), the RL agent 118 may provide an RL output to the switch 128. The RL output may indicate for a link associated with the first compute node 120 to be in a first state (e.g., active state) or in a second state (e.g., low-power state). In other words, based on the state representation for the first compute node 120 (e.g., the first GPU is processing data and is not planning on providing a data packet to a second GPU), the RL agent 118 may provide an RL output indicating for the link to transition to the low-power state and/or to remain in the low-power state. However, the state representation for the second compute node 122 and the third compute node 124 may indicate favorable conditions for transmitting data packets (e.g., indicating that the second and third GPUs are planning on providing data packets to other hardware components/elements within the data center). As such, the RL agent 118 may provide RL outputs to the switches 130 and 132. The RL outputs may indicate for the links to transition to the active state. Thus, when the second and third GPUs actually transmit the data packets, the links associated with the switches 130 and 132 may already be in the active state, which may facilitate communications as the data packets do not have to wait for the transition time period (e.g., the wake-up latency). By using these actions (e.g., transitioning/remaining in the low-power state or the active state), this may allow the RL agent 118 to proactively manage link power states based on learned predictions, which may balance energy saving goals against the performance implications of state transition latencies.

Returning back to FIG. 1A, the actions from the RL agent 118 may be provided back to the data simulators (e.g., the first, second, and third data simulators 112-116), and the data simulators (e.g., the simulated switches) may be configured to transition their switches and/or links based on the actions. The RL agent 118 may receive new datacenter simulator outputs (e.g., new state representations) at each time step. Thus, the RL agent 118 may provide new actions (e.g., transition/remain in the first state or the second state) at each time step. For instance, after receiving and/or processing the actions from the RL agent 118 (e.g., transition to the active state), the first datacenter simulator 112, the second datacenter simulator 114, and the third datacenter simulator 116 may each generate and/or provide new state representations to the RL agent 118. Then, the RL agent 118 may generate actions for each of the datacenter simulators 112-116 and provide the generated actions to the datacenter simulators 112-116. This may repeat for one or more iterations. In some examples, for each subsequent time step, the state representations may be refreshed based on both: (i) the workload-driven traffic patterns, and (ii) the most recent link actions taken. In the training environment, the parallel training environment 104 may replay the workload traces and update counters such as idle time, time-in-current-state, and/or traffic history, producing a new feature vector for the RL agent 118. During deployment (e.g., inference), the same process may occur in real time using hardware counters and timers at the switch ports. In either case, the prior RL action (e.g., keeping a link active or transitioning it to sleep) changes the link's state, which in turn directly affects the features observed at the next time step. Thus, the evolution of the state representation may be a closed loop (e.g., workload events and agent actions may jointly determine the updated feature values presented to the RL agent 118).

Furthermore, during the training process, the RL agent 118 may be trained using one or more rewards (e.g., a reward function). For instance, at each time step, a reward may be crafted (e.g., determined and/or calculated) to guide the RL agent 118 towards dual objectives of maximizing energy conservation and minimizing negative performance impacts. For instance, the reward may include an energy savings bonus (e.g., a positive reward proportional to the duration the link successful spends in a low-power state, directly reflecting conserved energy) and a forced wake-up penalty (e.g., a significant negative reward issued if a data packet arrives when the link is in a low-power state, thereby forcing an unplanned (and high-latency) transition to the active mode). In some instances, additional and/or alternative rewards may also be utilized to train the RL agent 118, including, but not limited to, a regulation toggle reward (e.g., a reward that minimizes the time to toggle between states) and/or heuristics rewards (e.g., a maximize delay time for packet reward and/or a number of packets that were delayed reward). Thus, the immediate, per-step reward structure may be a form of reward shaping. For instance, the ultimate optimization objective may be to maximize total energy saved over entire operational cycles while minimizing job completion time increases. However, such objectives provide only sparse reward signals. Therefore, embodiments of the present disclosure may utilize shaped proxy rewards that deliver denser feedback, which may be crucial for efficient learning in complex environments. Based on the rewards, aspects of the RL agent 118 (e.g., the parameters of the RL agent 118) may be trained.

For instance, as mentioned above, the rewards may be based on a reward function that is a weighted combination of an Energy Savings Bonus and a Forced Wake-Up Penalty. For instance, the Energy Savings Bonus may be a positive reward that is proportional to the duration that the link successfully spends in a low-power state and the Forced Wake-Up Penalty may be a significant negative reward issued if a data packet arrives when the link is in a low-power state, which forces an unplanned transition to the active mode. Thus, by using these two rewards, this allows for maximizing total energy saved over entire operational cycles while minimizing job completion time increases. In some embodiments, the rewards function rₜ may be expressed as:

rₜ=α·TimeInLowPowerStateₜ−β·ForcedWakeUpEventₜ

where α and β are hyperparameters, TimeInLowPowerStateₜ is the Energy Savings Bonus reward, and ForcedWakeUpEventₜ is the Forced Wake-Up Penalty reward.

In other words, the overview 100 integrates the RL agents 118 with the parallel training environment 104. For instance, embodiments of the present disclosure may use real-world traffic traces from diverse LLM training workloads (e.g., within the workload dataset 102) to drive multiple parallel instances using the parallel training environment 104. Each instance may provide observations to its assigned link agents (e.g., the RL agent 118), which may execute their chosen actions, and return the corresponding rewards and next states.

The learning process itself may adhere to a distributed PPO optimization scheme. The RL agent 118 operating within each parallel training environment 104 may collect interaction trajectories (rollouts). These rollouts, comprising (sₜ, aₜ, rₜ, sₜ₊₁) transitions from all agents across all environments, are aggregated. Advantage estimates may then be computed using Generalized Advantage Estimation (GAE). To ensure robust generalization and prevent overfitting to the training traces, embodiments of the present disclosure may periodically checkpoint and evaluate policy models on held-out segments of the traffic data.

For deployment in a production environment, embodiments of the present disclosure may be quantized to 8-bit Integer (INT8) precision, enabling its implementation as a lightweight and efficient module within switch hardware with minimal computational overhead during live inference.

The RL agent 118 may be and/or include one or more components such as neural networks (NNs), multilayer perceptions (MLPs), and/or other components, entities, and/or aspects. In some examples, the RL agent 118 may be and/or include a CNN and an MLP, which is shown in FIG. 1E. In other examples, the RL agent 118 may include other components. Non-limiting examples of the components and layout of the RL agent 118 are shown in FIGS. 1C-1E.

For instance, FIG. 1C shows an exemplary embodiment of the RL agent 118, in accordance with an embodiment. As mentioned previously, the datacenter simulator outputs (e.g., a first datacenter simulator output from the first datacenter simulator 112) may include a state representation. For instance, the state representation may include a consecutive idle time, a time in current power state, a recent traffic-triggered wake-up, and/or traffic history features. In some examples, embodiments of the present disclosure may process (e.g., using one or more encoders) the state representation to obtain vectors and/or other data representations that may be in a data format that the multilayer perceptron (MLP) 154 may be able to process. For instance, the idle history 152 may represent a data representation for the traffic history features that may be processable by the MLP 154 and/or other NNs (e.g., a convolutional NN (CNN)). Similarly, the feature vector 150 may represent a data representation for the consecutive idle time, the time in current power state, and the recent traffic-triggered wake-up that is processable by the MLP 154 and/or other NNs. The feature vector 150 may be concatenated with the idle history 152 to obtain a concatenated input that is provided to the MLP 154. The MLP 154 may process the concatenated input to generate the action 156, which as described above, may indicate whether to transition/remain in a first state or second state (e.g., in a low-power state or active state).

FIG. 1D shows another exemplary embodiment of the RL agent 118, in accordance with an embodiment. For instance, instead of using a single MLP, in some embodiments, the RL agent 118 may use two MLPs 164 and 168. Specifically, the first MLP 164 may be used to process the idle history 162 that is associated with the traffic history features to generate the latent idle history 166. The feature vector 160, which may be associated with the consecutive idle time, the time in current power state, and the recent traffic-triggered wake-up, may be concatenated with the latent idle history 166 to generate a concatenated input. Following, the second MLP 168 may perform the functionalities of the MLP 154 from FIG. 1C and process the concatenated input to generate the action 170. In other words, FIG. 1D uses an initial MLP (e.g., the first MLP 164) to preprocess the link idle time history, and the resulting embedding (e.g., the latent idle history 166) may be concatenated with other state features (e.g., the feature vector 160) and fed into the second MLP 168.

FIG. 1E shows yet another exemplary embodiment of the RL agent 118, in accordance with an embodiment. For instance, instead of using an MLP to process the idle history 182, FIG. 1E uses a CNN 184 to process the idle history 182 to generate the latent idle history 186. Subsequently, the feature vector 180 may be concatenated with the latent idle history 186 to generate a concatenated input that is provided to the MLP 188. The MLP 188 may process the concatenated input to generate the action 190. In other words, FIG. 1E may use a one-dimensional (1D) CNN 184 to extract patterns from the idle time history 182. For instance, CNNs may excel at identifying temporal patterns in communication cycles typical of machine learning (ML) workloads, and the CNN output (e.g., the latent idle history 186) may be concatenated with the remaining state features (e.g., the feature vector 180), and then processed by the MLP 188.

In some instances, as mentioned above, the RL agent 118 (e.g., the RL agents 118 shown in FIGS. 1C-1E) may be trained using Proximal Policy Optimization (PPO), which may be an actor-critic RL algorithm known for its stability and sample efficiency. As such, at each time step, the rewards described above (e.g., the energy savings bonus, the forced wake-up penalty, and/or additional/alternative rewards) may be determined and used to train aspects of the RL agent 118. For instance, based on the rewards, the parameters of the MLP 154, 164, and 168 and/or the CNN 184 may be updated and/or adjusted.

In some instances, the RL agent 118 may share parameters during training, but may act independently during inference based on local observations. For example, embodiments of the present disclosure may employ a distributed multi-agent approach where each network link and/or switch may be managed by a dedicated lightweight RL agent 118. This distributed setup with independent RL agents 118 may enable scalable deployment across potentially thousands of links in a datacenter while maintaining low computational overhead per link.

Additionally, and/or alternatively, embodiments of the present disclosure may also feature symmetric observation handling, discrete action outputs, weight sharing across links for better generalization, and/or minimal parameters for efficient hardware implementation.

In other words, embodiments of the present disclosure may employ a distributed multi-agent approach where each network link is managed by a dedicated, lightweight agent. These agents (e.g., the RL agents 118) may be trained using PPO. This distributed setup with independent agents may enable scalable deployment across potentially thousands of links in a data center while maintaining low computational overhead per link.

Each RL agent 118 may use a NN that outputs both policy (actor) and value function (critic). Three exemplary RL agents 118 are shown in FIGS. 1C-1E, which differ primarily in how they process traffic history. For instance, in FIG. 1C, an example RL agent 118 is shown that uses a standard MLP 154. The MLP 154 directly processes the complete flattened state (e.g., the feature vector 150 and the idle history 152). In FIG. 1D, the example RL agent 118 uses an initial MLP 164 to preprocess link idle time history (e.g., the idle history 162). The resulting embedding (e.g., the latent idle history 166) is concatenated with other state features (e.g., the feature vector 160) and fed into a second MLP 168. In FIG. 1E, another example RL agent 118 uses a 1D CNN 184 to extract patterns from idle time history (e.g., extracting the latent idle history 186 from the idle history 182). CNNs excel at identifying temporal patterns in communication cycles typical of ML workloads. The CNN output (e.g., the latent idle history 186) is concatenated with remaining state features (e.g., the feature vector 180) and processed by an MLP 188. In some examples, the MLPs described in FIGS. 1C-1E (e.g., the MLPs 154, 164, 168, and 188 may use compact architectures (e.g., 64-32-32-16 units) for efficient inference. In the CNN-MLP example of FIG. 1E, the CNN layers of the CNN 184 may act as specialized encoders capturing temporal traffic patterns crucial for proactive link state transitions.

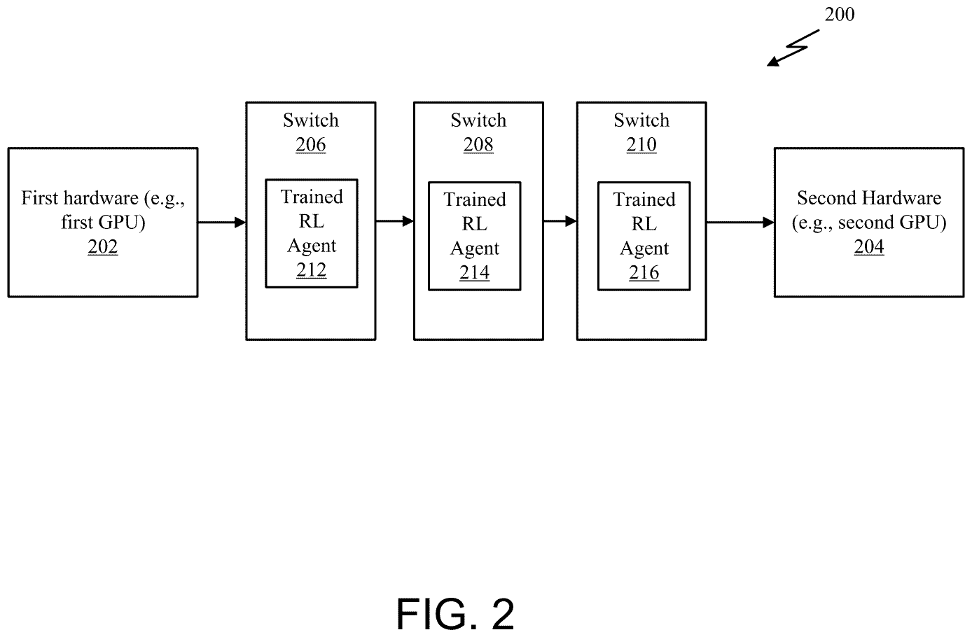

FIG. 2 shows an example 200 of an inference phase of using the RL agents in a distributed data center, in accordance with an embodiment. For instance, a first hardware 202 (e.g., a first GPU) may be electrically connected to a second hardware 204 (e.g., a second GPU) via circuitry that includes switches 206-210. As mentioned above, each electrical connection between a first entity and a second entity may involve a network link that may be controlled by a trained RL agent 212-216. For instance, after training the RL agent 118, the parameters of the RL agent 118 may be cloned and/or duplicated and then distributed across a datacenter environment. For instance, the switch 206-210 may be located at different physical locations within the datacenter environment and a link (e.g., an electrical connection) may connect the switches 206-210 to each other as well as the first and second GPUs 202 and 204. Only three switches 206-210 are shown for simplicity; however, the data center environment may include a plurality of different switches, which may be associated with a plurality of RL agents (e.g., each switch may include its own RL agent and/or each link for each switch may include its own RL agent). In addition, each switch within the data center environment may be connected to a plurality of different hardware (e.g., a plurality of GPUs). For instance, the switch 206 may be connected to a first set of GPUs (e.g., ten or one hundred GPUs) and may further be connected to a number of switches (e.g., the switch 208 as well as other switches). Similarly, while not shown, the switch 208 may be connected to a plurality of different hardware (e.g., a second set of GPUs) and switches (e.g., the switches 206 and 210 as well as other switches).

The trained RL agents 212-216 may be configured to obtain state representations (e.g., consecutive idle time, time in current power state, recent traffic-triggered wake-up, and/or traffic history features), process the state representations, and generate actions for the links. For instance, using the trained RL agent 212, the switch 206 may generate an action for the link between itself and switch 208. After generating the action, the switch 206 may implement the action such as transitioning and/or keeping the link between itself and switch 208 in an active state or a low-power state. For instance, the first hardware 202 may be processing information and thus the trained RL agent 212 may generate an action indicating for the link between itself and switch 208 to be in a low-power state. Afterwards, based on the action, the switch 206 may be configured to transition to the low-power state if the link was previously in an active state or remain in the low-power state if the link was previously in the low-power state. In some instances, the RL agents 212-216 may utilize symmetrical features, which ensure that for a link connecting two switches (e.g., the switch 206 and 208), the state observed would be identical regardless of which switch's agent (e.g., the trained RL agent 212 or 214) is making the decision.

In some examples, the trained RL agents 212-216 may obtain the state representations based on components and/or hardware associated with the ports of the switches such as the switches 206-210. For instance, the switches may include hardware timers, counters, and/or other hardware elements that are associated with each port. These hardware elements may be used to obtain the state representations.

In other words, embodiments of the present disclosure may utilize a multi-agent setting where numerous link agents make decentralized decisions. These decisions may collectively influence global network behavior; for example, an RL agent 118 putting a link to sleep might reroute traffic, thereby altering the traffic patterns observed by other agents. To address this inherent coupling, embodiments of the present disclosure may adopt a parameter-sharing strategy: a single neural network representing both actor and critic may be trained using the collective experiences gathered from all agents. These RL agents 118 operate concurrently within the shared parallel training environment 104, allowing the shared policy to implicitly learn coordinated or emergent behaviors that account for these networkwide effects. While the network parameters are shared, each RL agent 118 operates independently based solely on its local observations, both during training rollouts and during deployment. To effectively manage the large volume of experiences from many agents, potentially across multiple parallel simulation environments, embodiments of the present disclosure utilize a PPO implementation that includes a mechanism to handle distinct rollout buffers. These buffers collect experiences for different links or batches of RL agents 118, ensuring that trajectories are correctly processed for advantage estimation before being aggregated for gradient computation. This approach results in a single, trained policy that can be uniformly deployed across all links in the datacenter, yet adapts its specific actions to each link's unique context through its local inputs.

Among other benefits and advantages, embodiments of the present disclosure provide for training a distributed RL framework for dynamic link power management of datacenter switches. The training includes using datacenter simulators (e.g., the datacenter simulators 112-116) to generate state representations indicating simulated states of a datacenter environment. The RL agent 118 is trained based on the generated state representations and a reward function. The reward function may include one or more rewards such as an energy savings bonus and/or a forced wake-up penalty. The training process is described in further detail in FIGS. 1A and 1B above. Additionally, and/or alternatively, embodiments of the present disclosure may be implemented and/or use the distributed RL framework to control network links for switches such as the switches 206-210 from FIG. 2. For instance, based on the obtained state representations, the trained RL agents (e.g., the trained RL agent 212) may generate an action such as to keep and/or transition the network link from a first state or a second state. Additionally, and/or alternatively, the RL agents from the distributed RL framework may include one or more MLPs and/or NNs. For instance, the RL agent 118 may include a single MLP 154, two MLPs 164 and 168, and/or a CNN 184 and an MLP 188.

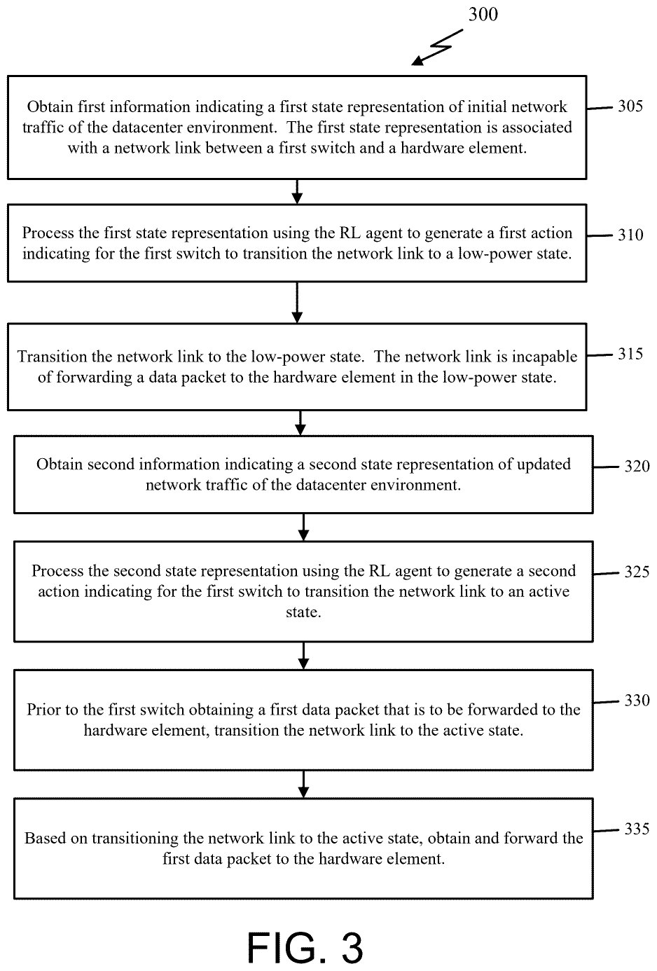

FIG. 3 illustrates a flowchart of a method 300 for controlling network links in a datacenter environment using an RL agent, in accordance with an embodiment. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to FIGS. 1A-1E and FIG. 2 described above. However, the method 300 may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 305, first information indicating a first state representation of initial network traffic of the datacenter environment is obtained. The first state representation is associated with a network link between a first switch and a hardware element. At step 310, the first state representation is processed using the RL agent to generate a first action indicating for the first switch to transition the network link to a low-power state.

In an embodiment, the RL agent comprises a multilayer perceptron (MLP), the first state representation comprises idle history data representation indicating traffic history features associated with the first switch and a feature vector, and processing the first state representation using the RL agent to generate the first action comprises: concatenating the idle history data representation and the feature vector to generate a concatenated input; and processing the concatenated input using the MLP to generate the first action. In an embodiment, the RL agent comprises a first multilayer perceptron (MLP) and a second MLP, the first state representation comprises idle history data representation indicating traffic history features associated with the first switch and a feature vector, and processing the first state representation using the RL agent to generate the first action comprises: processing the idle history data representation using the first MLP to generate a latent idle history data representation; concatenating the latent idle history data representation and the feature vector to generate a concatenated input; and processing the concatenated input using the second MLP to generate the first action. In an embodiment, the RL agent comprises a convolutional neural network (CNN) and a multilayer perceptron (MLP), the first state representation comprises idle history data representation indicating traffic history features associated with the first switch and a feature vector, and processing the first state representation using the RL agent to generate the first action comprises: processing the idle history data representation using the CNN to generate a latent idle history data representation; concatenating the latent idle history data representation and the feature vector to generate a concatenated input; and processing the concatenated input using the MLP to generate the first action.

At step 315, the network link is transitioned to the low-power state. The network link is incapable of forwarding a data packet to the hardware element in the low-power state. At step 320, second information indicating a second state representation of updated network traffic of the datacenter environment is obtained. At step 325, the second state representation is processed using the RL agent to generate a second action indicating for the first switch to transition the network link to an active state. At step 330, prior to the first switch obtaining a first data packet that is to be forwarded to the hardware element, the network link is transitioned to the active state. At step 335, based on transitioning the network link to the active state, the first data packet is obtained and forwarded to the hardware element.

In an embodiment, the hardware element is a second switch, the first switch comprises first memory that stores parameters of the RL agent, the second switch comprises second memory that stores parameters for a second RL agent, and the parameters of the RL agent and the parameters of the second RL agent are the same.

In an embodiment, the method 300 further comprises prior to obtaining the first information, training the RL agent based on using workload data from a workload dataset. In an embodiment, training the RL agent comprises: obtaining the workload data, wherein the workload data is large language model (LLM) training workload data; processing the LLM training workload data using a first datacenter simulator to generate a first training state representation for the RL agent; processing the first training state representation using the RL agent to generate a first action for the first datacenter simulator; and updating parameters of the RL agent based on computing one or more rewards associated with the first action for the first datacenter simulator. In an embodiment, the first training state representation comprises consecutive idle time information, time in current power state information, recent traffic-triggered wake-up information, and traffic history features. In an embodiment, the first action for the first datacenter simulator indicates for a compute node of the first datacenter simulator to be in the low-power state or the active state. In an embodiment, updating the parameters of the RL agent comprises: based on the first action, computing the one or more rewards, wherein the one or more rewards comprises an energy savings bonus reward and a forced wake-up penalty reward; and updating the parameters of the RL agent based on the one or more rewards.

In an embodiment, at least one of steps 305-335 and/or the further steps described above for method 300 are performed in a data center. In an embodiment, at least one of steps 305-335 and/or the further steps described above for method 300 is performed for a cloud computing environment. In an embodiment, at least one of steps 305-335 and/or the further steps described above for method 300 is performed for training, testing, or certifying a neural network employed in a machine, robot, or autonomous vehicle. In an embodiment, at least one of steps 305-335 and/or the further steps described above for method 300 is performed for a virtual machine comprising a portion of a graphics processing unit.

In contrast to conventional systems, embodiments of the present disclosure describe a LinkRL framework for dynamic link power management in datacenter switches. The LinkRL framework deploys lightweight RL agents that operate at the individual link level, and each agent learns an adaptive policy to toggle its link between active and low-power states based on observed traffic patterns. The LinkRL framework may perform predictive traffic modeling. For example, the RL agents may learn to anticipate future network activity, which may allow the RL agents to preemptively wake links before traffic arrives. This may minimize latency penalties and identify extended idle periods where links may safely sleep, which may maximize energy savings.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

In some examples, the machine learning model(s) (e.g., deep neural networks, language models, large language models (LLMs), language reasoning models (LRMs), vision language models (VLMs), multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Additionally, in some embodiments, the systems and methods described herein may be performed within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of the underlying algorithms, systems, image processing pipelines, and/or processes prior to deploying them in the real-world. In some instances, the simulation may be used to generate synthetic training data—e.g., training data including landmarks, features, objects, etc.—so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, extended reality (e.g., augmented reality, virtual reality, mixed reality), robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more language reasoning models (LRMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM), language reasoning model (LRM), or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, LRM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more LRMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

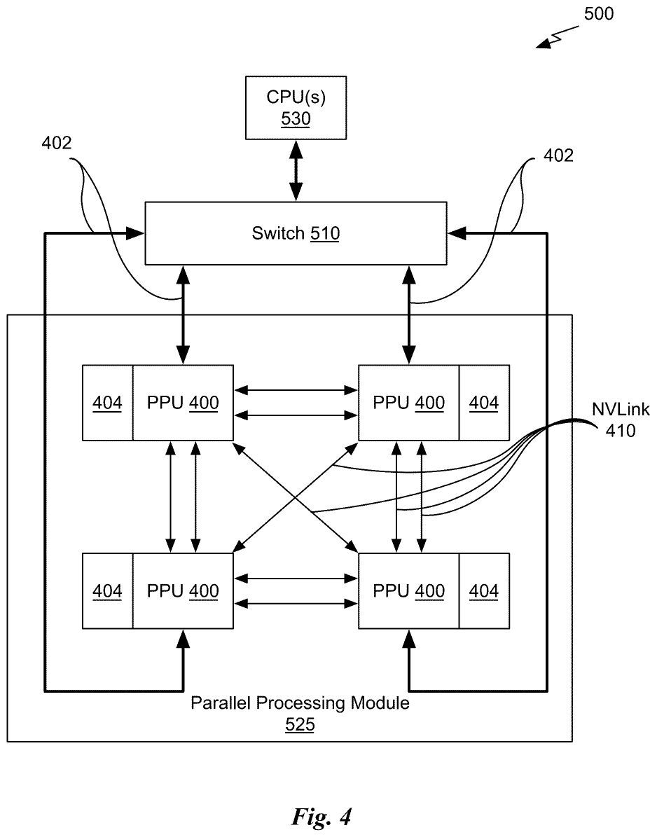

FIG. 4 is a conceptual diagram of a processing system 500 implemented using multiple PPUs 400, in accordance with an embodiment. The exemplary system 500 may utilized as a particular node—or portion thereof in—the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

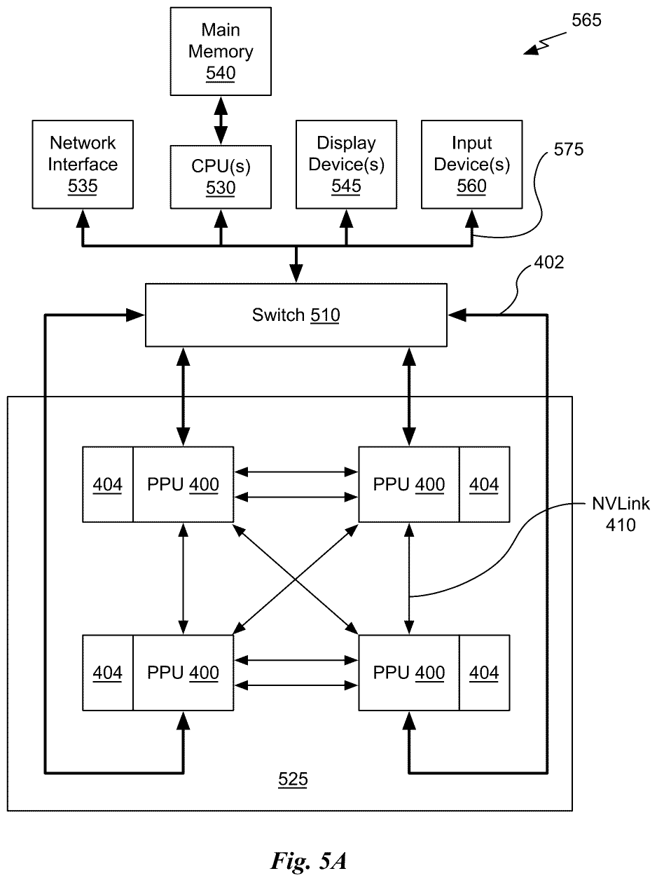

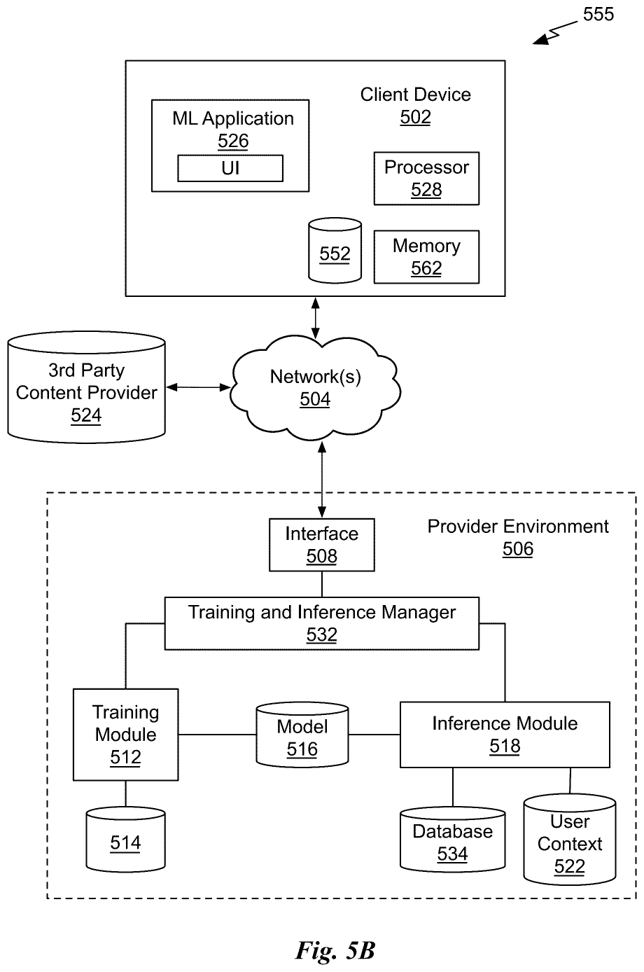

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

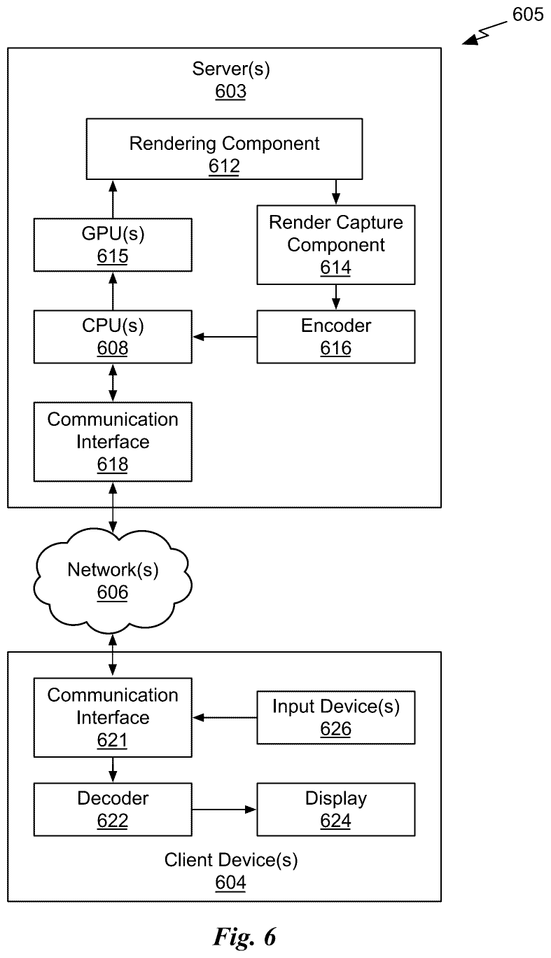

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for controlling network links in a datacenter environment using a reinforcement learning (RL) agent, comprising:
obtaining first information indicating a first state representation of initial network traffic of the datacenter environment, wherein the first state representation is associated with a network link between a first switch and a hardware element;
processing the first state representation using the RL agent to generate a first action indicating for the first switch to transition the network link to a low-power state;
transitioning the network link to the low-power state, wherein the network link is incapable of forwarding a data packet to the hardware element in the low-power state;
obtaining second information indicating a second state representation of updated network traffic of the datacenter environment;
processing the second state representation using the RL agent to generate a second action indicating for the first switch to transition the network link to an active state;
prior to the first switch obtaining a first data packet that is to be forwarded to the hardware element, transitioning the network link to the active state; and
based on transitioning the network link to the active state, obtaining and forwarding the first data packet to the hardware element.

2. The computer-implemented method of claim 1, wherein the hardware element is a second switch, wherein the first switch comprises first memory that stores parameters of the RL agent, and wherein the second switch comprises second memory that stores parameters for a second RL agent, wherein the parameters of the RL agent and the parameters of the second RL agent are the same.

3. The computer-implemented method of claim 1, further comprising:
prior to obtaining the first information, training the RL agent based on using workload data from a workload dataset.

4. The computer-implemented method of claim 3, wherein training the RL agent comprises:
obtaining the workload data, wherein the workload data is large language model (LLM) training workload data;
processing the LLM training workload data using a first datacenter simulator to generate a first training state representation for the RL agent;
processing the first training state representation using the RL agent to generate a first action for the first datacenter simulator; and
updating parameters of the RL agent based on computing one or more rewards associated with the first action for the first datacenter simulator.

5. The computer-implemented method of claim 4, wherein the first training state representation comprises consecutive idle time information, time in current power state information, recent traffic-triggered wake-up information, and traffic history features.

6. The computer-implemented method of claim 4, wherein the first action for the first datacenter simulator indicates for a compute node of the first datacenter simulator to be in the low-power state or the active state.

7. The computer-implemented method of claim 4, wherein updating the parameters of the RL agent comprises:
based on the first action, computing the one or more rewards, wherein the one or more rewards comprises an energy savings bonus reward and a forced wake-up penalty reward; and
updating the parameters of the RL agent based on the one or more rewards.

8. The computer-implemented method of claim 1, wherein the RL agent comprises a multilayer perceptron (MLP), wherein the first state representation comprises idle history data representation indicating traffic history features associated with the first switch and a feature vector, and wherein processing the first state representation using the RL agent to generate the first action comprises:
concatenating the idle history data representation and the feature vector to generate a concatenated input; and
processing the concatenated input using the MLP to generate the first action.

9. The computer-implemented method of claim 1, wherein the RL agent comprises a first multilayer perceptron (MLP) and a second MLP, wherein the first state representation comprises idle history data representation indicating traffic history features associated with the first switch and a feature vector, and wherein processing the first state representation using the RL agent to generate the first action comprises:
processing the idle history data representation using the first MLP to generate a latent idle history data representation;
concatenating the latent idle history data representation and the feature vector to generate a concatenated input; and
processing the concatenated input using the second MLP to generate the first action.

10. The computer-implemented method of claim 1, wherein the RL agent comprises a convolutional neural network (CNN) and a multilayer perceptron (MLP), wherein the first state representation comprises idle history data representation indicating traffic history features associated with the first switch and a feature vector, and wherein processing the first state representation using the RL agent to generate the first action comprises:
processing the idle history data representation using the CNN to generate a latent idle history data representation;
concatenating the latent idle history data representation and the feature vector to generate a concatenated input; and
processing the concatenated input using the MLP to generate the first action.

11. The computer-implemented method of claim 1, wherein at least one of the steps of obtaining, processing, transitioning, and forwarding are performed in a data center.

12. The computer-implemented method of claim 1, wherein at least one of the steps of obtaining, processing, transitioning, and forwarding is performed for a cloud computing environment.

13. The computer-implemented method of claim 1, wherein at least one of the steps of obtaining, processing, transitioning, and forwarding is performed for training, testing, or certifying a neural network employed in a machine, robot, or autonomous vehicle.

14. The computer-implemented method of claim 1, wherein at least one of the steps of obtaining, processing, transitioning, and forwarding is performed for a virtual machine comprising a portion of a graphics processing unit.

15. A system for controlling network links in a datacenter environment using a reinforcement learning (RL) agent, comprising:
one or more processors; and
a non-transitory computer-readable medium having processor-executable instructions stored thereon, wherein the processor-executable instructions, when executed by the one or more processors, facilitate:
obtaining first information indicating a first state representation of initial network traffic of the datacenter environment, wherein the first state representation is associated with a network link between a first switch and a hardware element;
processing the first state representation using the RL agent to generate a first action indicating for the first switch to transition the network link to a low-power state;
transitioning the network link to the low-power state, wherein the network link is incapable of forwarding a data packet to the hardware element in the low-power state;
obtaining second information indicating a second state representation of updated network traffic of the datacenter environment;
processing the second state representation using the RL agent to generate a second action indicating for the first switch to transition the network link to an active state;
prior to the first switch obtaining a first data packet that is to be forwarded to the hardware element, transitioning the network link to the active state; and
based on transitioning the network link to the active state, obtaining and forwarding the first data packet to the hardware element.

16. The system of claim 15, wherein the hardware element is a second switch, wherein the first switch comprises first memory that stores parameters of the RL agent, and wherein the second switch comprises second memory that stores parameters for a second RL agent, wherein the parameters of the RL agent and the parameters of the second RL agent are the same.

17. The system of claim 15, wherein the RL agent comprises a multilayer perceptron (MLP), wherein the first state representation comprises idle history data representation indicating traffic history features associated with the first switch and a feature vector, and wherein processing the first state representation using the RL agent to generate the first action comprises:
concatenating the idle history data representation and the feature vector to generate a concatenated input; and
processing the concatenated input using the MLP to generate the first action.

18. The system of claim 15, wherein the RL agent comprises a convolutional neural network (CNN) and a multilayer perceptron (MLP), wherein the first state representation comprises idle history data representation indicating traffic history features associated with the first switch and a feature vector, and wherein processing the first state representation using the RL agent to generate the first action comprises:
processing the idle history data representation using the CNN to generate a latent idle history data representation;
concatenating the latent idle history data representation and the feature vector to generate a concatenated input; and
processing the concatenated input using the MLP to generate the first action.

19. A non-transitory computer-readable medium having processor-executable instructions stored thereon for controlling network links in a datacenter environment using a reinforcement learning (RL) agent, wherein the processor-executable instructions, when executed, facilitate:
obtaining first information indicating a first state representation of initial network traffic of the datacenter environment, wherein the first state representation is associated with a network link between a first switch and a hardware element;
processing the first state representation using the RL agent to generate a first action indicating for the first switch to transition the network link to a low-power state;
transitioning the network link to the low-power state, wherein the network link is incapable of forwarding a data packet to the hardware element in the low-power state;
obtaining second information indicating a second state representation of updated network traffic of the datacenter environment;
processing the second state representation using the RL agent to generate a second action indicating for the first switch to transition the network link to an active state;
prior to the first switch obtaining a first data packet that is to be forwarded to the hardware element, transitioning the network link to the active state; and
based on transitioning the network link to the active state, obtaining and forwarding the first data packet to the hardware element.

20. The non-transitory computer-readable medium of claim 19, wherein the RL agent comprises a convolutional neural network (CNN) and a multilayer perceptron (MLP), wherein the first state representation comprises idle history data representation indicating traffic history features associated with the first switch and a feature vector, and wherein processing the first state representation using the RL agent to generate the first action comprises:
processing the idle history data representation using the CNN to generate a latent idle history data representation;
concatenating the latent idle history data representation and the feature vector to generate a concatenated input; and
processing the concatenated input using the MLP to generate the first action.
